(19) United States
(12) Patent Application Publication
(10) Pub. No.: US 2004/0191416 A1
(43) Pub. Date: Sep. 30, 2004

(54) Coating device and process for a wet section of an apparatus for production of a material web

(75) Inventors: Peter Gallina, Herbrechtingen (DE); Volker Schmidt-Rohr, Heidenheim (DE); Karl Stelner, Herbrechtinggen (DE); Michael Trefz, Appleton, WI (US)

Correspondence Address: GREENBLUM & BERNSTEIN, P.L.C., 1950 ROLAND CLARKE PLACE, RESTON, VA, 20191, US

(73) Assignee: VOITH SULZER PAPIERTECHNIK PATENT GmbH, Heidenheim (DE)

(21) Appl. No.: 10/810,866

(22) Filed: Mar. 29, 2004

Related U.S. Application Data
(63) Continuation of application No. 09/512,304, filed on Feb. 24, 2000, now abandoned.
Application No. 09/512,304 is a continuation of application No. 09/176,962, filed on Oct. 22, 1998, now abandoned.

(30) Foreign Application Priority Data
Oct. 24, 1997 (DE) 197 47 091.2
May 27, 1998 (DE) 198 23 739.1
May 8, 1998 (DE) 198 20 516.3
May 6, 1998 (DE) 297 23 289.4

(51) Int. Cl. B05D 3/12; B05D 1/36

(52) U.S. Cl. 427/361; 427/365; 427/411

(57) ABSTRACT

Process for application of a coating medium on a traveling material web that is one of paper and cardboard, the coating medium including at least one of a pasty medium and a liquid medium, wherein the process includes forming a material web in a wet section of a machine for one of paper and cardboard and guiding the material web which is still wet with a traveling, endless, carrier belt during application of a coating medium. The application of the coating medium includes transferring the coating medium from a roll-coating mechanism to at least one transfer belt onto the still wet material web. The coating medium is transferred from a surface of the at least one transfer belt moving in a direction of travel of the material web. The at least one transfer belt is a traveling, endless, air-permeable transfer belt which is guided by rolls. This Abstract is not intended to define the invention disclosed in the specification, nor intended to limit the scope of the invention in any way.

### CROSS-REFERENCE TO RELATED APPLICATIONS

The present application is a continuation application of U.S. application Ser. No. 09/512,304, filed Feb. 24, 2000, the disclosure of which is expressly incorporated by reference in its entirety, which is a continuation application of parent U.S. application Ser. No. 09/176,962, filed Oct. 22, 1998, now abandoned, the disclosure of which is expressly incorporated by reference in its entirety. The present application also claims priority under 35 U.S.C. § 119 of German Patent Application No. 197 47 091.2, filed Oct. 24, 1997, German Patent Application No. 198 23 739.1, filed May 27, 1998, German Patent Application No. 198 20 516.3, filed May 8, 1998, and German Application No. 297 23 289.4, filed May 6, 1998, the disclosures of which are expressly incorporated by reference herein in their entireties.

### BACKGROUND OF THE INVENTION

1. Field of the Invention

The invention concerns devices and processes for the direct or indirect application of a fluid or pasty medium on a fully formed but still wet material web, in particular made of paper or cardboard.

2. Discussion of Background Material

From DE-OS 19 42 348, the disclosure of which is herein incorporated by reference in its entirety, a coating device is known, for example, wherein the coating medium is applied to a material web accommodated between two fourdrinier screens. Furthermore, suction devices which remove moisture from the still wet web are provided. Because of the relatively loose guidance of the web inherent to the fourdrinier screens in a direction perpendicular to the plane of the web, the web has a relatively loose structure in the region of the coating device. Consequently, the coating material applied to the material web tends to penetrate into the interior of the web and does not remain, as is actually desired, in the region of the surface of the material web. Thus, with the coating device known from DE-OS 19 42 348, the coating quality required in modern paper or cardboard production machines cannot be obtained.

In U.S. Pat. No. 5,152,872, the disclosure of which is herein incorporated by reference in its entirety, a coating device for a wet material web is described in which a fibrous web lies on a wire fabric. On the side of the fibrous web not in contact with the wire fabric—in the belt contact region of a supporting roll—an additional rotating roll transfers the coating medium to the surface of the fibrous web. A pair of rolls touches the generating line of the application roll. The coating medium is metered in the upper wedge of the pair of rolls. By rolling all three of these rolls, the coating medium is distributed on the surface of the application roll. A disadvantage of this design is the rapidly opening gap between the area of the supporting roll, which is looped by the wire fabric and the fibrous pulp web and the applicator roll after coating. This is caused by the radius of curvature of the application roll. Through the adhesion of the coating medium both on the surface of the fibrous web and on the surface of the application roll, there is flaking on the surface. A further disadvantage of this arrangement is the design consisting of three rolls. This makes the design expensive. Due to the three roll arrangement, space requirement is also significant since the coating device must be positioned directly on the path of the web.

In U.S. Pat. No. 4,793,899, the disclosure of which is herein incorporated by reference in its entirety, the application of a medium occurs in the press section of a paper machine. Here, the fibrous web likewise lies on a conveyor belt; in this case, a press felt. A coating device-described there as a “short-dwell coater”—applies the coating medium to a press roll surface which has no felt. In conjunction with another roll, this press roll forms a press nip. With the rolling of the press roll surface on the fibrous web, the coating medium is transferred to the surface and pressed into the fibrous strip. As the fibrous web leaves the press nip, there is again the above-described disadvantage of flaking with this design. The surface of a fibrous web which has been provided with a coating medium in the manner described above has a rough surface. This can lead to problems during coating. A significant cause of the flaking is found in the coating nip which opens too quickly. This opening speed becomes an increasingly greater problem the faster the paper machines run.

Moreover, with the coating device known from U.S. Pat. No. 4,793,899, the problems resulting from an excessively loose structure of the material web do not occur so much and do not affect coating quality so strongly; however, the coating medium is so intensely pressed into the material web in the gap formed between the two rolls that the objective expressly stated in U.S. Pat. No. 4,793,899 of keeping the coating material as near the surface of the web as possible is not achieved to the extent desired.

In addition to this, the coating device known from U.S. Pat. No. 4,793,899 has many guide and press rolls for the material web as well as for the wire fabrics guiding it and thus is expensive.

### SUMMARY OF THE INVENTION

According to a first aspect of the invention, an object of the invention is to provide a coating device for the wet portion of a machine for the production of a material web, in particular, made of paper or cardboard, which enables keeping the coating medium applied to the web near its surface. Moreover, a second aspect of the invention is to avoid flaking in the application of the coating medium. Both of these aspects are made possible through the simple configuration of the coating device and process of the present invention.

Accordingly, the design of a device for the direct or indirect application of a fluid or pasty medium on a fully formed but still wet material web, in particular of paper or cardboard, is proposed. The device may include a roll, whereby the roll guides the web along a section of the its circumference in a belt contact region, and includes a coating mechanism for the application of the fluid or pasty medium onto the surface of the material web or the surface of the roll, and includes at least one screen or wire fabric belt carrying the material web, whereby the screen or wire fabric belt is positioned between the coating mechanism and the material web and the coating medium comes into contact with the material web in the belt contact region of the roll.

The mode of operation of the coating device according to the invention is based primarily on the combination of two characteristics, i.e., first, that the coating medium comes into contact with the material web in the belt contact region of the roll, and second, that the coating medium is always applied through a screen or wire fabric onto the material web, regardless of whether the coating medium is applied to the web from its inside out or from its outside in. In this regard, the terms “inside” and “outside” refer to the curved path of the material web in the belt contact region, i.e., “inside” means the side of the material web facing the roll, while “outside” means the side of the material web away from the roll.

If the coating mechanism is positioned on the outside of the web, the screen or wire fabric belt positioned between the material web and the coating mechanism results in a compacting of the fiber structure of the material web. Thus, the coating medium applied cannot penetrate into the interior of the material web and remains in the region of the outer surface of the material web. If, on the other hand, the coating mechanism and thus the screen or wire fabric belt as well are positioned on the inside of the material web, the material web is compacted as a result of the already existing cohesion of the fibrous structure of the material web, which in turn renders penetration of the coating medium into the interior of the material web difficult. At the same time, the screen or wire fabric belt acts as a pressure buffer for the hydrodynamic pressure which builds upon entry into the belt contact region. Thus, the pressure cannot reach a value which could enable the coating medium to penetrate through the compacted region into the interior of the material web. As a result, no mating roll is provided on the outside of the material web. Consequently, the material web can avoid pressure peaks of the coating medium being applied and thus prevent penetration of the coating medium into the interior of the material web. In addition, the coating device according to the invention has a simple structure since in its basic design, it requires only one contact roll, one screen or wire belt, and one coating mechanism.

Both in the case of placement of the coating mechanism on the outside of the material web and with its placement on the inside of the material web, it is advantageous to accommodate the material web between two screen or wire fabric belts. In the first case, the second web belt provided on the inside of the material web prevents direct contact of the material web with the roll surface, which prevents damage to the material web resulting from unwanted adhesion to the roll surface, especially at the end of the belt contact region. In the second case, the second screen or wire fabric belt provided on the outside of the material web contributes to compaction of the material web.

In the case of application from the outside of the material web in, the coating mechanism may, according to one embodiment, be in sliding contact with the screen or wire fabric belt. This embodiment makes it possible to ensure in a simple manner that the coating medium passes through the screen or wire fabric belt into contact with the material web. Here, the coating mechanism may have a coating chamber from which the coating medium comes out under pressure and is brought into contact with the material web through the screen or wire fabric belt. By means of suitable selection of the value of the pressure prevailing in the coating chamber, it is possible for the coating medium to be pressed into the material web to a desired depth.

According to an alternative embodiment, the coating mechanism may, however, also be positioned at a distance from the screen or wire fabric belt and be designed, for example, as an open-jet spray coating mechanism. Here, the coating medium passes only “gradually” through the screen or wire fabric belt and into contact with the material web.

In both embodiments, a removal device may be positioned downstream from the coating mechanism to remove excess coating medium from the material web. Especially in conjunction with the previously discussed first embodiment, the removal device may be positioned immediately downstream from the coating mechanism. To ensure the most uniform coating possible, an equalization device may additionally or alternatively be positioned downstream from the coating mechanism to equalize the coating medium and, if desired, to remove excess coating medium from the material web. This equalization device may, for example, include a scraper device or another known doctor knife element.

Also in the case of coating from the inside of the material web out, i.e., coating with involvement of the surface of the roll, the coating mechanism may, according to a first embodiment, be in sliding contact with the surface of the roll or, according to a second embodiment, be positioned at a distance from the surface of the roll.

In each of the aforementioned cases, it is advantageous if the roll has at least one suction zone extending over part of the belt contact region. In the case of coating from the outside of the material web in, the moisture present in the still wet material web is sucked to the roll, which makes anchoring of the coating medium in the region of the outer surface of the material web easier. In the case of coating from the inside of the material web out, it is possible to again remove excess coating medium by means of the suction zone.

As has already been indicated for one embodiment, the coating mechanism may have a coating chamber in which the coating material is under pressure. For example, a pressure of preferably between about 300 Pa and 10 kPa, more preferably between about 500 Pa and 5 kPa may prevail in the coating chamber. The exposure time may preferably be between about 1 and 10 milliseconds. To enable the most economical handling of the coating medium, it is further proposed that the coating mechanism be designed for metered delivery of the coating medium.

The radius of the roll may preferably be between about 200 mm and 1200 mm. And finally, the solids content of the paper web may preferably be between about 5 wt % and 50 wt %, more preferably between about 8 wt % and 17 wt %, and the solids content of the coating medium may preferably be between about 5 wt % and 50 wt %, more preferably between about 10 wt % and 30 wt %, whereby the coating medium may contain, for example, water, mineral fillers such as kaolin, CaCO₃, TiO₂, and the like, binders such as starch, latex, or the like, retention agents, and optical brighteners.

The invention also includes not using a roll as a coating element, but rather creating a slowly opening coating gap in another manner, wherein the transfer of the coating medium onto the material web occurs by means of a transfer belt slowly approaching the fibrous web and likewise slowly moving away from the fibrous web after coating. In particular, depending upon the speed of the material web, the angles formed by the material web and the transfer belt before and after the nip are preferably about 2° to 45°, more preferably about 10° to 15°.

This embodiment has several advantages: for one, the coating medium comes into contact with the material web before the press nip, which lengthens the exposure period of the coating medium on the material web. For another, the speed of separation of the transfer belt from the material downstream from the press nip is significantly reduced compared to roll coating. To prevent the entrained air boundary layer from presenting a disruptive barrier between the coating medium and the material web in this narrow coating wedge on the felts and the web, the transfer belt should be air permeable. Air permeability is also preferred when the transfer nip opens, so that the material web can separate from the transfer belt.

The coating medium may be applied to the transfer belt by means of an application roll. The coating medium in turn may be applied to the circumference of the application roll by means of a doctor knife device. The coating device according to the invention consists of a transfer belt and a coating mechanism. The coating mechanism may be implemented as an application roll. It is, however, also conceivable that a coating mechanism with an associated pair of rolls (three-roll system) be used to wet the transfer belt.

An additional advantage of the coating device described is that one part of the coating device—the transfer belt—is already present in most cases and thus there is no additional space requirement. The other part of the coating device—the coating mechanism—may be positioned at a greater distance from the web, where adequate space exists.

The coating device according to the invention can be installed at various locations in the region of the wet section and/or the press section of a paper machine.

One advantageous implementation location is at the beginning of the press section. The fibrous web arrives, drained by the screen section, with the help of a felt from the screen section to the first press nip of the press section. A second felt, which has been provided with the coating medium by the coating mechanism, runs together with the first felt into the first press nip in a wedge shape. Due to the still high water content of the fibrous web, penetration of the coating medium into the fibrous web is typical for this embodiment.

It may also be advantageous that additional draining of the fibrous web not occur until in the press section in the first press nip. Because of the changed properties of the fibrous web after the first press, application of coating medium with the device according to the invention in this region results in different fibrous web properties.

It is further advantageous that a fibrous web be provided with coating medium not only once on one side, but rather in two or even more coating stages. Here, the coating medium can be adjusted in consistency and/or composition from one application site to another.

According to the invention, the transfer belt does not have to be a press felt. A screen or wire fabric which has adequate absorption capacity for the coating medium and a fine enough mesh not to leave a mesh pattern on the fibrous web is also suitable as a transfer belt.

It may also be advantageous that the coating device according to the invention be implemented in the belt contact region of the suction roll of the screen section. For one thing, the fibrous web still has a very loose fiber bond there such that the coating medium can penetrate particularly intensively into the fiber bond. For another, the suction zone of the suction roll supports this effect.

In accordance with one aspect, the present invention is directed to a device for at least one of direct and indirect application of a coating medium on a fully formed but still wet material web, the coating medium being at least one of a fluid and pasty medium. The coating device includes a roll having a circumference and capable of guiding a material web along a part of the circumference in a belt contact region, a coating mechanism capable of applying a coating medium on at least one of a surface of the material web and the circumference of the roll, such that the coating medium comes into contact with the material web in the belt contact region of the roll, and at least one screen belt that contacts the roll in the belt contact region, the at least one screen being capable of supporting the material web.

In accordance with another aspect, the material web comprises a material selected from the group consisting of paper and cardboard.

In accordance with another aspect, the at least one screen belt is capable of being positioned between the coating mechanism and the material web.

In accordance with yet another aspect, the coating mechanism is capable of being positioned on a side of the material web opposite from the roll.

In accordance with still another aspect, the coating mechanism is in sliding contact with the at least one screen belt.

In accordance with another aspect, the coating mechanism is positioned at a distance from the at least one screen belt.

In accordance with still another aspect, the coating device further includes a removal device positioned downstream from the coating mechanism to remove excess coating medium from the material web. The removal device may be positioned immediately downstream from the coating mechanism. The removal device may comprise a suction device positioned on the paper side.

In accordance with another aspect, the coating device further includes an equalization device positioned downstream from the coating mechanism to equalize the coating medium. The equalization device may be capable of removing excess coating medium from the material web. The equalization device may include a scraper device.

In accordance with yet another aspect, the coating mechanism is capable of applying the coating medium on a surface of the roll. The coating mechanism may be in sliding contact with the surface of the roll. The coating mechanism may be positioned at a distance from the surface of the roll.

In accordance with another aspect, the roll has a suction zone over at least part of the belt contact region.

In accordance with another aspect, the coating mechanism has a coating chamber capable of holding coating medium under pressure. The coating chamber may be capable of holding the coating medium under a pressure of between about 300 Pa and 10 kPa, preferably between about 500 Pa and 5 kPa. The device may be capable of providing an exposure time of the material web to the coating medium at the coating chamber of between about 1 and 10 milliseconds.

In accordance with another aspect, the coating mechanism is capable of metered delivery of the coating medium.

In accordance with another aspect, the coating mechanism comprises an open-jet spray coating mechanism.

In accordance with still another aspect, the at least one screen belt comprises two screen belts which are capable of holding the material web therebetween.

In accordance with another aspect, the roll has a radius between about 200 mm and 1200 mm.

In accordance with yet another aspect, the material web has a solids content of between about 5 wt % and 50 wt %, preferably between about 8 wt % and 17 wt %.

In accordance with another aspect, the coating medium has a solids content of between about 5 wt % and 50 wt %, preferably between about 10 wt % and 30 wt %.

In accordance with one aspect, the present invention is directed to a paper machine with a device for application of a coating medium on a traveling material web of one of paper and cardboard with a wet section, a press section, and a drying section. The paper machine includes at least one transport device for a material web in a wet section, the at least one transport device comprising an endless, air-permeable carrier belt, and at least one coating mechanism capable of applying a coating medium, the at least one coating mechanism capable of being positioned on a side of the material web which is opposite to a side of the material web which contacts the at least one transport device, the at least one coating mechanism comprising an endless, air-permeable transfer belt, the endless, air-permeable transfer belt being capable of applying the coating material to the material web.

In accordance with another aspect, the at least one coating mechanism comprises a roll-coating mechanism capable of applying the coating medium on the endless, air-permeable transfer belt. The roll-coating mechanism may have a single roll or may comprise a plurality of rolls.

In accordance with still another aspect, the transfer belt may comprise a press felt.

In accordance with yet another aspect, the transfer belt may comprise a screen.

In accordance with one aspect, the present invention is directed to a process for application of a coating medium on a traveling material web comprising one of paper and cardboard, the coating medium comprising at least one of a pasty medium and a liquid medium. The process includes forming a material web in a wet section of a machine for one of paper and cardboard, and guiding the material web which is still wet with a traveling, endless, carrier belt during application of a coating medium, the application of the coating medium comprising transferring the coating medium from at least one transfer belt onto the still wet material web, the coating medium being transferred from a surface of the at least one transfer belt moving in a direction of travel of the material web, the at least one transfer belt being a traveling, endless, air-permeable transfer belt.

In accordance with another aspect, the carrier belt is air-permeable.

In accordance with another aspect, the material web lies on a screen of a screen section during application of the coating medium.

In accordance with another aspect, the material web lies on a felt of a press section during application of the coating medium.

In accordance with yet another aspect, the coating medium is applied to only one side of the material web.

In accordance with another aspect, the coating medium is applied to two sides of the material web.

In accordance with still another aspect, the coating medium is applied to the material web prior to at least one of a first press and a second press in a press section.

In accordance with another aspect, the coating medium is applied to the material web after a first press in a press section.

In accordance with yet another aspect, the coating medium is applied to the material web in a carrier belt contact region with a screen suctioning roll in a screen section.

In accordance with another aspect, the coating medium is applied to at least one side of the material web inside a wet section.

In accordance with another aspect, the coating medium is applied to the material web through both felts of a dual—felt press of a press section.

In accordance with another aspect, the coating medium comprises different coating media having different compositions which are applied at different locations.

It is understood that the aforementioned characteristics and those subsequently to be explained are applicable not only in the respective combination indicated, but also in other combinations or in isolation without leaving the scope of the invention.

### BRIEF DESCRIPTION OF THE DRAWINGS

The present invention is further described in the detailed description which follows, in reference to the noted plurality of non-limiting drawings, and wherein:

FIGS. 1 and 2 illustrate embodiments in which the coating medium is applied to the material web from its outside in;

FIGS. 3-5 illustrate embodiments in which the coating medium is applied to the material web from the its inside out;

FIG. 6 illustrates an enlarged depiction to explain the coating principle of the embodiment according to FIG. 1;

FIG. 7 illustrates a partial view of a paper machine at the transition between the wet section and the press section;

FIG. 8 illustrates a partial view of a paper machine from the end of the wet section to the beginning of the drying section;

FIG. 9 illustrates a partial view of a paper machine from the end of the wet section including the press section; and

FIG. 10 illustrates a partial view of a paper machine at the transition from the wet section to the press section with positioning of the coating device according to the invention in the region of the suction roll.

### DETAILED DESCRIPTION OF THE INVENTION

The particulars shown herein are by way of example and for purposes of illustrative discussion of the various embodiments of the present invention only and are presented in the cause of providing what is believed to be the most useful and readily understood description of the principles and conceptual aspects of the invention. In this regard, no attempt is made to show details of the invention in more detail than is necessary for a fundamental understanding of the invention, the description taken with the drawings making apparent to those skilled in the art how the several forms of the invention may be embodied in practice. All percent measurements in this application, unless otherwise stated, are measured by weight based upon 100% of a given sample weight. Thus, for example, 30% represents 30 weight parts out of every 100 weight parts of the sample.

Unless otherwise stated, a reference to a compound or component, includes the compound or component by itself, as well as in combination with other compounds or components, such as mixtures of compounds.

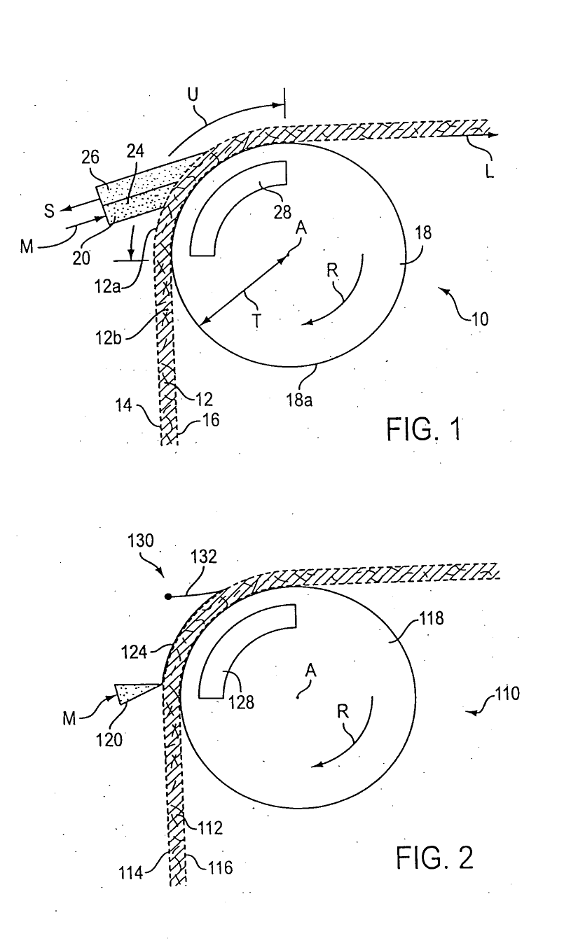

In FIG. 1, a first embodiment of the coating device according to the invention is collectively referenced by the number 10. The coating device is positioned in the wet section of a machine for the production of a material web 12, in particular made of paper or cardboard. As one may see in FIG. 1, the still wet material web 12 is accommodated between two screen or wire fabric belts 14 and 16, which ensure the cohesion of the fiber structure of the material web 12. In addition to the screen or wire fabric belts 14 and 16, the material web 12 is guided around a roll 18 and in a belt contact region U lies against the surface 18a of the roll 18. The roll 18 is rotationally driven around its axis A in the direction of the arrow R such that the material web 12 engages with the surface 18a of the roll 18 essentially slip-free upon its movement in the operating direction L.

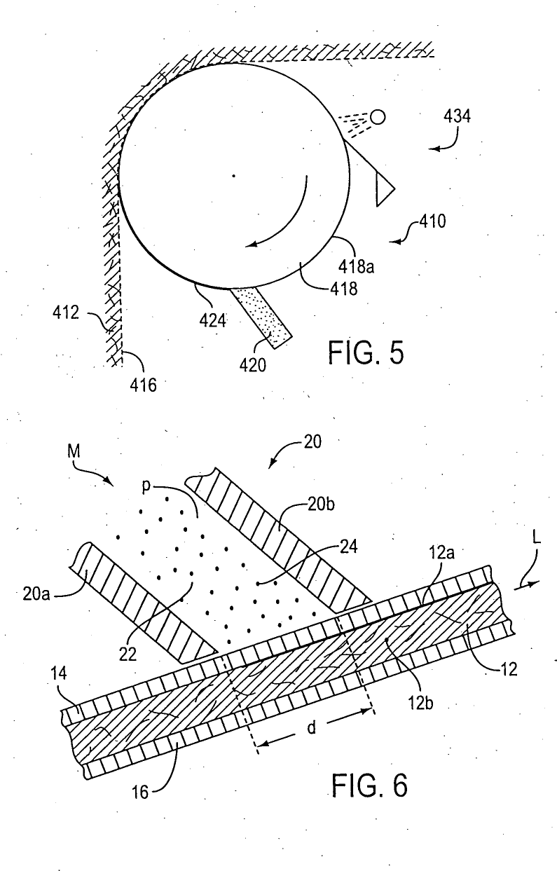

On the outside of the material web 12, i.e., on the side of the material web 12 facing away from the roll 18, a coating mechanism 20 is positioned, the configuration and function of which are to be explained in detail below with reference to FIG. 6.

FIG. 6 again depicts the material web 12 accommodated by two screen or wire fabric belts 14 and 16 as well as the coating mechanism 20. In the enlarged schematic cross-section depiction of FIG. 6, the coating mechanism 20 comprises an upstream boundary wall 20a and downstream boundary wall 20b, which are in sliding contact with the screen or wire fabric belt 14. The two boundary walls 20a and 20b as well as side boundary walls (not depicted) surround a coating chamber 22 open on the screen or wire fabric belt 14, to which coating medium 24 is added from the outside (arrow M). The distance d between the coating chamber walls 20a and 20b in the direction of travel L of the material web 12 is selected to yield a dwell time of the material web 12 in the region of the coating mechanism 20 of roughly about 1 to 10 milliseconds with the usual travel speeds of the material web 12. In addition, the coating medium 24 in the coating chamber 22 is under a pressure p of preferably between about 300 Pa and 10 kPa, more preferably between about 500 Pa and 5 kPa. The pressure is selected such that, on the one hand, the coating medium 24 is pressed through the screen or wire fabric belt 14 into a region 12a near the surface of the material web 12 during the dwell time of the material web 12 in the region of the coating mechanism 20 in sufficient quantity and is anchored there in its fiber structure, but, on the other hand, does not penetrate into the interior 12b of the material web 12.

As depicted in FIG. 1, the direction of travel L immediately connected with the coating mechanism 20 is provided with a suction device 26 by means of which the coating medium which has not adequately bonded with the material web 12 can again be removed from it. The quantity S of the coating medium sucked out may, after filtering out any fiber material sucked out with it, again be supplied to the coating mechanism 20, whereby dilution of the coating medium by any moisture also removed can be compensated for, if desired, by addition of coating medium with appropriately high solids content. The boundary walls of the suction device 26 are preferably in sliding contact with the screen or wire fabric belt 14, whereby the necessary sealing effect against the surroundings can be ensured.

The roll 18 may be equipped at least over a portion of belt contact region U with a suction zone 28. Such rolls with suction zones are known such that it is unnecessary to describe their structure in detail at this point. The suction zone 28 serves primarily to remove moisture from the material web 12, naturally causing the moisture present in the material web 12 to be sucked away from the surface area 12a and through the screen or wire fabric belt 16. Since the surface region 12a thus becomes drier, the coating medium 24 can more readily penetrate into it and become anchored there in the fibrous structure of the material web 12.

FIG. 2 depicts another embodiment of a coating device according to the invention, which corresponds essentially to that according to FIG. 1. Analogous parts are, consequently, identified by the same reference characters, but increased by the number 100. The coating device 110 according to FIG. 2 is described below to the extent that it differs from the coating device 10 according to FIG. 1, whose description is otherwise hereby referred to.

The coating device 110 according to FIG. 2 differs from that according to FIG. 1 in that on the side of the material web 112 accommodated between screen or wire fabric belts 114 and 116 turned away from the roll 118, an open-jet spray coating mechanism 120 is positioned, which is placed at a distance from the material web 112 or the screen or wire fabric belt 114 and applies the coating medium 124 premetered onto the material web 112 or the screen or wire fabric belt 114. An equalization device 130, which in the embodiment according to FIG. 2 comprises a scraper device 132, but which may be designed in principle as any other known doctor knife or equalization device, is positioned downstream from the coating mechanism 120. The equalization device 130 smooths the coating medium 124 applied and removes any excess coating medium 124 applied, to return it via an intermediate cleaning step to the feed flow M to the spray coating mechanism 120. Corresponding to the embodiment of FIG. 1, the roll 118 also has a suction zone 128.

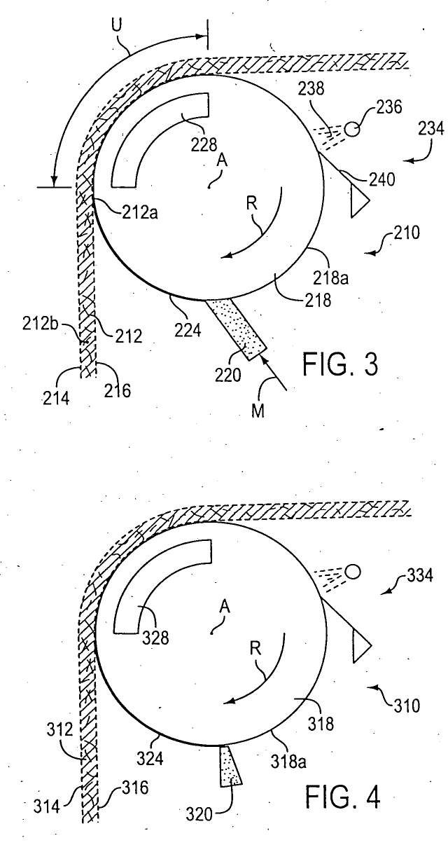

FIG. 3 depicts another embodiment of a coating device according to the invention, which corresponds essentially to that of FIG. 1. Analogous parts are, consequently, identified in FIG. 3 by the same reference characters as in FIG. 1, but increased by the number 200. The coating device 210 according to FIG. 3 is described below to the extent that it differs from the coating device 10 according to FIG. 1, whose description is otherwise hereby referred to.

The coating device 210 according to FIG. 3 differs from the embodiment according to FIG. 1 in particular in that the coating mechanism 220 is positioned on the side of the material web 212 facing the roll 218. The coating mechanism 220 is in principle designed exactly as has been described for the coating mechanism 20 with reference to FIG. 6. However, the boundary walls of the coating mechanism 220 are in sliding contact with the surface 218a of the roll 218 such that a layer of coating medium 224 is applied on surface 218a. This coating layer is moved forward to the belt contact region U as a result of the rotation of the roll 218 around the axis A in the direction of the arrow R, with the coating medium 224 being brought into contact with the material web 212. In particular, upon entry into the belt contact region U, the coating medium 224 is pressed into the material web 212 as a result of the hydrodynamic pressure developing between the roll surface 218a and the material web 212. The intermediate positioning of the screen or wire fabric belt 216 ensures that the pressure does not assume such high values that the coating medium 224 would be pressed into the interior 212b of the material web 212, but rather remains on the surface 212a of the material web 212. Furthermore, in the embodiment according to FIG. 3, no mating roll is provided on the side of the material web 212 facing away from the roll 218, such that the development of hydrodynamic pressure is prevented and penetration of the coating medium 224 into the interior of the material web 212 is prevented.

In the embodiment according to FIG. 3, the suction zone 228 serves primarily to suction off excess coating medium 224 applied to the material web 212 and to return it after intermediate cleaning to the feed flow M to the coating mechanism 220. In FIG. 3, a cleaning device 234 is also provided to clean the surface 218a of the roll 218. The cleaning device 234 comprises a delivery device 236 to apply a cleaning medium 238, e.g., water, steam, anti-bonding agents, chemical barriers, and tensides, to the roll surface 218a as well as a scraper knife 240 to remove contaminants from the surface 218a.

FIG. 4 depicts another embodiment of a coating device according to the invention, which corresponds essentially to that according to FIG. 3. Analogous parts are, consequently, identified by the same reference characters as in FIG. 3, but increased by the number 100, i.e., by the number 300 compared to FIG. 1. The coating device 310 according to FIG. 4 is described below to the extent that it differs from the coating device 210 according to FIG. 3, whose description is otherwise hereby referred to.

The coating device 310 according to FIG. 4 differs from the coating device 210 according to FIG. 3 to the extent that instead of the coating mechanism 220, an open-jet spray coating mechanism 320 is provided, which meters the coating medium 324 onto the surface 318a of the roll 318. As a result of the rotation around the axis A in the direction of arrow R, the coating medium is forwarded to the material web 312 accommodated between the screen or wire fabric belts 314 and 316. Otherwise, the embodiment according to FIG. 4 corresponds to the embodiment according to FIG. 3 including the provision of a suction zone 328 and a cleaning device 334.

FIG. 5 depicts another embodiment of a coating device according to the invention, which corresponds essentially to that according to FIG. 3. Analogous parts are, consequently, provided in FIG. 5 with the same reference characters as in FIG. 3, but increased by the number 200, i.e., by the number 400 compared to FIG. 1. The coating device 410 according to FIG. 5 is described below to the extent that it differs from the coating device 210 according to FIG. 3, whose description is otherwise hereby referred to.

The coating device 410 according to FIG. 5 differs from the coating device 210 according to FIG. 3 only in that the material web 412 is supported by a screen or wire fabric belt 416 only on the side facing the application roll 418. Furthermore, the roll 418 has in the embodiment according to FIG. 5 no zone corresponding to the suction zone 228. The roll 418 may thus, for example, be a simple guide roll for the material web 412. With regard to the application of the coating medium 424 by means of the coating mechanism 420 on the roll surface 418a and the forwarding of the coating medium 424 to the material web 412, the embodiment according to FIG. 5 corresponds to that according to FIG. 3. And finally, a cleaning device 434 is provided.

As can be seen from the Figures, the coating mechanism may be positioned in one of: (1) a position below and adjacent to the roll to apply the coating medium to the roll, and (2) a position adjacent to the belt contact region to apply the coating medium directly onto the material web in the belt contact region.

Although only embodiments for one-sided coating of a fluid or pasty medium have been described above, it is understood that the coating device according to the invention may also be designed for two-sided coating. Any combination of the “outside” coating device according to FIGS. 1 and 2 with any of the “inside” coating devices according to FIGS. 3 and 4 is possible.

It should however be added that the solids content of the material web 12 in the region of the coating mechanism 20 may preferably be between about 5 wt % and 50 wt %, more preferably between about 8 wt % and 17 wt %, while the solids content of the coating medium 24 may preferably be between about 5 wt % and 50 wt %, more preferably between about 5 wt % and 30 wt %, even more preferably between about 10 wt % and 30 wt %. Here, the solids content of the material web is understood to mean the percent by mass of solid matter, for example, fibers, fillers, and the like, based on the total mass of the material web consisting of fibers, fillers, water, and the like. Moreover, the solids content of the coating medium means the percent by mass of solid matter, for example, mineral pigments, binders, auxiliary materials, and the like, based on the total mass of the coating medium containing additional fluid components, primarily water. The coating medium may, for example, be composed of water, mineral fillers, such as kaolin, CaCO₃, TiO₂, and the like, binders such as starch, latex, or the like, retention agents, e.g., available under the trade names “Nalco 74503”, “Percol” available from Ciba-Allied Colloids, “Polymin” available from BASF, “BMA” and “BMB” both available from Eka Chemicals, “Compozil System”, and optical brighteners, e.g., available under the trade names “Aphranil”, “Leukophor”, “Tinopal”, and “Blanchophor”.

It should also be added that the increase in mass due to the application of the fluid or coating medium per side amounts preferably to between about 1 g/m² and 10 g/m².

The coating device according to the invention can, for example, be used in a dual-web former and, because of its design, can replace a film press, which increases the efficiency of the machine for the production of the material web.

Reference should again be made to the fact that the material web is compacted in the belt contact region such that the coating medium is uniformly distributed on its surface instead of soaking it completely, i.e., penetrating into the interior of the material web. Overall, it is thus possible to achieve with the coating device according to the invention a more uniform smooth coating with less coating weight.

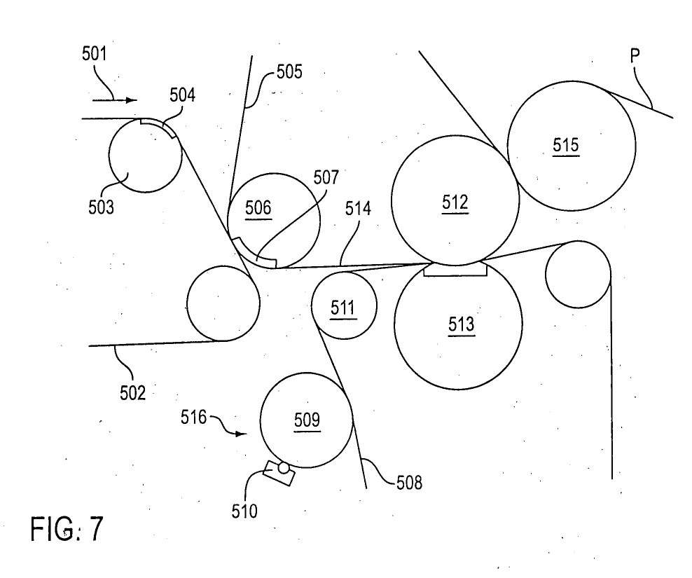

In FIG. 7, the material web (fibrous material web) P moves in the indicated direction of the arrow 501. The material web P runs—lying on the screen or wire fabric 502—over suction roll 503 into the press section. In the deflection process on the suction roll 503, the material web P is held by suction zone 504 on screen or wire fabric 502. A first felt 505 of the press section picks up the material web P with the help of pickup roll 506 and its suction zone 507 from the screen or wire fabric 502. A second felt 508 of the press section is wetted with coating medium by means of application roll 509 and an associated doctor knife device 510 (together they form coating mechanism 516). After deflection of the felt 508 on felt guide roll 51 1, it runs along with the felt 505 into a press nip. The press nip is formed by press roll 512 and a flexible press roll 513 with a press shoe. The intake gap 514 is exaggerated in the drawing in its opening angle which, depending upon the speed of the material web, is preferably about 2° to 45°, more preferably about 10° to 15°. Thus, the distance from the roll 511 to the felt 505 can be only a few millimeters. In the press nip between the rolls 512 and 513, the coating medium is transferred to the material web P under pressure and with a significantly longer exposure time than in a roll application system. After the material web P and the felts 505 and 508 have left the press nip, the felt 5

runs back to the coating mechanism 516. The felt 505 and the material web P lying on it continue to run together through a press nip between rolls 512 and 515. After this gap the material web P partially runs around the roll 515 and is either guided to another press nip or to a drying section.

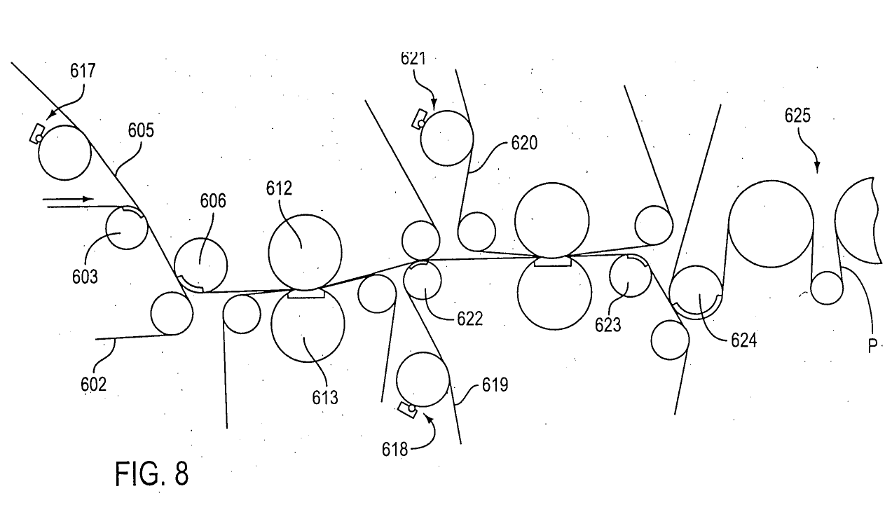

Another embodiment of a coating mechanism according to the invention is depicted in FIG. 8. Here in FIG. 8, first upper felt 605 is wetted with a coating medium by means of a coating mechanism 617 on its surface which later comes into contact with material web P. Screen or wire fabric 602, the felt 605, and the material web P travel together on suction roll 603. On a long stretch between the suction roll 603 and suction take-up roll 606, the coating medium reacts on the material web P. After passing through the first press nip of rolls 612, 613, the web comes into contact with suction take-up roll 622. This releases the material web P from the felt 605 and transfers it onto felt 619. The felt 619 has been wetted with a coating medium by a coating mechanism 618. On the felt 619, the material web P now makes contact with the coating medium on its other surface. Another coating mechanism 621 wets felt 620. Thus, as it travels through the subsequent press nip, the material web P is coated again on its upper side. When the material web P has left this press nip, it is guided—diverted along with the felt 619 by suction felt guide roll 623—to dry suction roll 624. Then, the material web P is dried in drying section 625.

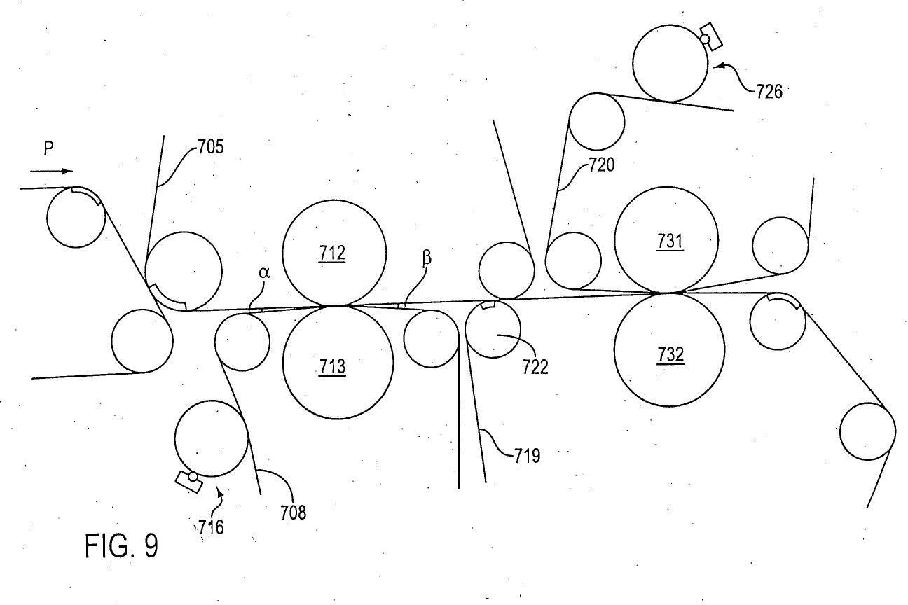

FIG. 9 depicts another embodiment of a coating device according to the invention. Similar to FIG. 8, in FIG. 9 material web P passes through two successive press roll pairs 712, 713 and 731, 732. Both an angle a before the nip and an angle β after a nip are, depending upon the speed of the material web, preferably about 2° to 45°, more preferably about 10° to 15°. A coating mechanism 716 wets both felt 708 and the material web P on its bottom side. After the transfer of the material web P onto felt 719 by means of suction take-up roll 722, the material web P is guided to the press nip of the rolls 731, 732. A felt 720 traveling in the material web P has been wetted with coating medium by coating mechanism 726. In this press nip, the material web P is coated on its upper side. After leaving the press nip, the material web P—as already described for FIG. 8—is guided to a drying section (not shown). Although in FIG. 9 different press nip forms from those in FIG. 8 are seen, here again there is a sharp intake and opening angle which facilitates a long exposure time to the coating medium and the careful opening of the coating gap.

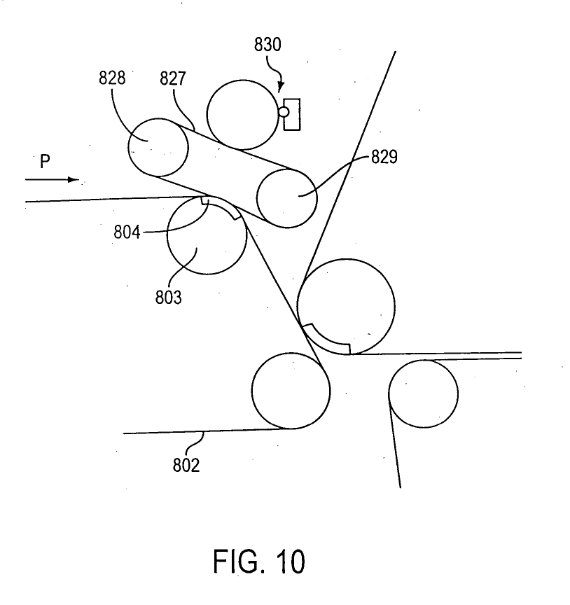

A special application case of another embodiment of a coating device according to the invention is depicted in FIG. 10. Here, by means of an additional screen loop or felt loop 827 and additional rolls 828 and 829 in the deflection region of suction roll 803 or its suction zone 804, a coating medium is applied to the top side of the material web P, which lies on screen or wire fabric 802. The loop 827 is wetted by coating mechanism 830. This device can be useful if one wishes to use the properties of the material web P at this point of the suction roll 803 and the mode of action of the suction zone 804. Because of the loose fiber bond, it is possible to apply a coating medium particularly well on and in the material web P. However, because the material web P is still very loose here, application of a medium which supports web stability may be useful.

While the invention has been described in connection with certain preferred embodiments so that aspects thereof may be more fully understood and appreciated, it is not intended to limit the invention to these particular embodiments. On the contrary, it is intended to cover all alternatives, modifications and equivalents as may be included within the scope of the invention as defined by the appended claims.

What is claimed is:

1. A process for application of a coating medium on a traveling material web comprising one of paper and cardboard, the coating medium comprising at least one of a pasty medium and a liquid medium, the process comprising:
forming a material web in a wet section of a machine;
guiding the material web while still wet between at least one transfer belt and at least one traveling, endless, air-permeable transfer belt; and
applying a coating medium to the still wet material web,
wherein the applying comprises transferring the coating medium from a roll-coating mechanism through the at least one transfer belt and onto the still wet material web while the at least one transfer belt, the still wet material web, and the at least one traveling, endless, air-permeable transfer belt move in a direction of travel.

2. The process of claim 1, wherein the at least one transfer belt is air-permeable.

3. The process of claim 1, wherein the at least one transfer belt comprises a press felt.

4. The process of claim 1, wherein the at least one transfer belt comprises a screen.

5. The process of claim 1, wherein the at least one traveling, endless, air-permeable transfer belt comprises a screen.

6. The process of claim 1, wherein the guiding occurs in a press section.

7. The process of claim 1, wherein the applying comprises applying the coating medium to only one side of the still wet material web.

8. The process of claim 1, wherein the applying comprises applying the coating medium to two sides of the still wet material web.

9. The process of claim 1, wherein the applying comprises applying the coating medium to the still wet material web prior to a first press in a press section.

10. The process of claim 1, wherein the applying comprises applying the coating medium to the still wet material web after at least one of a first press and a second press in a press section.

11. The process of claim 1, wherein the roll comprises a screen suctioning roll.

12. The process of claim 1, wherein the applying comprises applying the coating medium to at least one side of the still wet material web inside a wet section.

13. The process of claim 1, wherein the applying comprises applying the coating medium to both sides of the still wet material web in a dual-felt press of a press section.

14. The process of claim 1, further comprising applying an additional coating medium at a different location from the applying.

15. The process of claim 1, wherein the material web has a solids content of between about 5 wt % and 50 wt %.

16. The process of claim 1, wherein the material web has a solids content of between about 8 wt % and 17 wt %.

17. The process of claim 1, wherein the coating medium has a solids content of between about 5 wt % and 50 wt %.

18. The process of claim 1, wherein the coating medium has a solids content of between about 10 wt % and 30 wt %.

19. The process of claim 1, further comprising applying an additional coating medium to the material web, wherein a composition of the additional coating medium is different than a composition of the coating medium.

20. A process for application of a coating medium on a traveling material web comprising one of paper and cardboard, the coating medium comprising at least one of a pasty medium and a liquid medium, the process comprising:
forming a material web in a wet section of a machine;
guiding the material web while still wet between at least one transfer belt and a traveling, endless, carrier belt; and
applying with a coating chamber a coating medium under pressure onto the still wet material web through the at least one transfer belt while the at least one transfer belt, the still wet material web, and the at least one traveling, endless, carrier belt move in a direction of travel,
wherein the material web is exposed to the coating medium for an exposure time of between about 1 and 10 milliseconds.

21. The process of claim 20, wherein the at least one traveling, endless, carrier belt is air-permeable.

22. The process of claim 20, wherein the at least one transfer belt comprises a press felt.

23. The process of claim 20, wherein the at least one transfer belt comprises a screen.

24. A process of applying a coating medium on a fully formed but still wet material web, the coating medium being at least one of a fluid and pasty medium having a solids content of between about 5 wt % and 50 wt %, the process comprising:
guiding a material web and at least one screen belt over a roll having a radius between about 200 mm and 1200 mm, wherein the at least one screen belt contacts a circumference of the roll in a belt contact region;
applying, with a coating mechanism, the coating medium under pressure on at least one of a surface of the material web and the circumference of the roll, wherein the coating medium comes into contact with the material web in the belt contact region; and
selecting the pressure such that the coating medium is pressed through the at least one screen belt for a dwell time and in sufficient quantity that the coating medium anchors into the material web but does not penetrate into an interior of the material web.
